(19) United States
(12) Patent Application Publication
(10) Pub. No.: US 2026/0046348 A1
(43) Pub. Date: Feb. 12, 2026

(54) MAPPING BETWEEN TIME-SENSITIVE NETWORK DATA PACKETS AND ARINC 664 PART 7 DATA PACKETS

(71) Applicant: GE Aviation Systems LLC, Grand Rapids, MI (US)

(72) Inventors: Scott Larson, Byron Center, MI (US); Harry Molling, Kentwood, MI (US)

(21) Appl. No.: 19/293,326

(22) Filed: Aug. 7, 2025

Related U.S. Application Data
(60) Provisional application No. 63/681,795, filed on Aug. 10, 2024.

(51) Int. Cl. H04L 69/325; H04L 12/46

(52) U.S. Cl. CPC H04L 69/325; H04L 12/4645

(57) ABSTRACT

Systems, methods, and other embodiments described herein relate to mapping data packets between an ARINC 664 Part 7 (A664P7) data format and a Time-Sensitive Network (TSN) data format. In one embodiment, a method includes, in response to receiving a first data packet in a first data transmission format from a first data end system, forming a second data packet in a second data transmission format based on the first data packet. The first data end system is capable of transmitting and receiving data packets in the first data transmission format. The first data transmission format is one of A664P7 data format and TSN data format and the second data transmission format is the other of A664P7 data format and TSN data format. The method further includes transmitting the second data packet to a second data end system that is capable of receiving data packets in the second data transmission format.

### CROSS-REFERENCE TO RELATED APPLICATION

This patent application makes reference to, claims priority to, and claims benefit from U.S. Provisional Ser. No. 63/681,795 titled “Mapping between Time-Sensitive Network Data Packets and ARINC 664 Part 7 Data Packets” filed on Aug. 10, 2024; which is hereby incorporated herein by reference in its entirety.

### TECHNICAL FIELD

The subject matter described herein relates, in general, to systems and methods for mapping data packets between two different data transmission formats - Time-Sensitive Network (TSN) data format and ARINC 664 Part 7 (A664P7) data format.

### BACKGROUND

For contemporary aircraft, an avionics ‘platform’ consists of a variety of elements such as sensors, data concentrators, a data communications network, radio frequency sensors and communication equipment, computational elements, effectors, and graphical displays. These components must share error-free information with other components over the data communications network in a timely manner.

Network components utilized to construct the data communications network can utilize a specialized data protocol, including relays, switches, communicative connections, and the like, to ensure performance of the network architecture for the specialized data, as for example, under the performance of the network communications defined by the ARINC 664 Part 7 specification, the IEEE 802.1 specifications, and the IEEE 802.3 specifications.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates an example of a network system that includes an ARINC 664 Part 7-Time-Sensitive Network (A664P7-TSN) switch.

FIG. 2 illustrates an example of a data packet in A664P7 data format.

FIG. 3 illustrates an example of a data packet in TSN data format.

FIG. 4 illustrates one embodiment of the A664P7-TSN switch that includes an A664P7-TSN switch controller.

FIG. 5 shows the A664P7-TSN switch controller.

FIG. 6 is a flowchart illustrating one embodiment of a method for mapping between A664P7 data packets and TSN data packets.

FIGS. 7A-7B are flowcharts illustrating a method for mapping between A664P7 data packets and TSN data packets.

FIG. 8 is a flowchart illustrating one embodiment of a method for high integrity ordinal integrity validation.

FIG. 9 is a flowchart illustrating one embodiment of a method for high integrity time integrity validation.

### DETAILED DESCRIPTION

Systems, methods, and other embodiments associated with a gateway between different data transmission protocols are disclosed. An aircraft network may be used to transfer, transmit, and/or receive data between applications and/or components within an aircraft and more generally, between applications and/or components within the aircraft and supporting the aircraft, internally and/or externally. Some components in the aircraft may utilize, transmit, and/or receive over an Avionics Full-Duplex Switched Ethernet (AFDX), which is also known as ARINC 664 P7 (A664P7). However, aircraft networks and aircraft network components are gradually transitioning to Time-Sensitive Network (TSN) systems, which use time synchronization amongst the components in the aircraft network so as ensure timing requirements are being met.

As networks and network components transition from A664P7 to TSN, some networks may include a combination of A664P7 legacy components and TSN components. However, data packets or packets from the A664P7 data end systems, referred to as A664P7 data packets have a different format from the data packets or packets from the TSN data end systems, referred to as TSN data packets. As such, A664P7 data end systems cannot receive, and process TSN data packets and TSN data end systems cannot receive and process A664P7 data packets. In other words, A664P7 data packets and TSN data packets are not compatible.

Current methods include systems that can receive and transmit both A664P7 data packets and TSN data packets. However, these systems are not capable of converting or mapping A664P7 data packets to TSN data packets and TSN data packets to A664P7 data packets.

Accordingly, systems, methods, and other embodiments associated with a gateway between A664P7 systems (and data packets) and TSN systems (and data packets) are disclosed. In one embodiment, the disclosed approach includes a gateway between A664P7 and TSN data buses. The method includes a data mapper that is capable of generating a TSN data packet based on an A664P7 data packet and generating an A664P7 data packet based on a TSN data packet. The method includes identifying normal integrity data packets or packets and high integrity data packets or packets. Normal integrity data packets do not include high integrity fields while high integrity data packets include high integrity fields such as a high integrity ordinal integrity field, a time integrity field, and a data integrity field.

High integrity ordinal integrity ensures that the data packet(s) are being received in a correct order. The method may include generating a sequence value for each data packet and including the sequence value in the packet. As an example, the sequence value may be included in a high integrity ordinal integrity field in the data packet(s). Further, the sequence value may be a 16-bit value in the User Data Protocol (UDP) payload of the data packet.

Time integrity ensures that the data packet(s) are received in a timely manner and within a suitable time frame. The method may include generating the timestamp within a time manager system and including the timestamp in the header of the data packet. As an example, the timestamp may be included in a time integrity field in the header of the data packet(s). Further, the timestamp may be a 48-bit value in the UDP payload of the data packet.

Data integrity ensures that the data packet(s) includes accurate data and accurate information. The method may include generating a signature or a checksum based on the contents of the data packet. As an example, the checksum may be two 16-bit CRC signatures based on a 1-way hash of source port ID, message sequence number, timestamp, and application data.

The method is based on, in one direction, transmitting an A664P7 data packet from an A664P7 data end system to a TSN data end system via a communication network, and in another direction, transmitting a TSN data packet from a TSN data end system to an A664P7 data end system via the communication network. The communication network includes one or more A664P7-TSN switches. The A664P7-TSN switch can receive A664P7 data packets from the A664P7 data end system via the communication network, map the A664P7 data packets to TSN data packets, and transmit the TSN data packets to the TSN data end system via the communication network. The A664P7-TSN switch can also receive TSN data packets from the TSN data end system via the communication network, map the TSN data packets to A664P7 data packets, and transmit the A664P7 data packets to the A664P7 data end system via the communication network.

The A664P7-TSN switch may include an A664P7-TSN switch controller, a data mapper, an integrity adder, and/or an integrity checker. The A664P7-TSN switch may include configuration settings that indicate whether the data packets are normal integrity or high integrity. The A664P7-TSN switch may be connected to and receive timing information from an A664P7 data end system time manager.

In a case where the configuration settings indicate that the data packets are normal integrity, in one direction, the A664P7-TSN switch receives a TSN data packet, maps the TSN data packet to an A664P7 data packet using the data mapper, and transmits the A664P7 data packet to an A664P7 data end system. In the other direction, the A664P7-TSN switch receives an A664P7 data packet, maps the A664P7 data packet to a TSN data packet using the data mapper, and transmits the TSN data packet to a TSN data end system.

In a case where the configuration settings indicate that the data packets are high integrity, in one direction, the A664P7-TSN switch receives a TSN data packet, maps the TSN data packet to an A664P7 data packet using the data mapper, adds one or more integrity fields using the integrity adder and timing information from the A664P7 data end system time manager, and then transmits the A664P7 data packet to an A664P7 data end system. In the other direction, the A664P7-TSN switch receives an A664P7 data packet and determines the validity of the A664P7 data packet using the integrity checker and timing information from the A664P7 data end system time manager. Upon determining that the A664P7 data packet is valid, the A664P7-TSN switch maps the A664P7 data packet to a TSN data packet using the data mapper and transmits the TSN data packet to a TSN data end system.

The embodiments disclosed herein present various advantages over conventional technologies that operate in networks that include and operate in both A664P7 and TSN transmission protocols. First, the embodiments enable aircraft networks to use a mix of systems that operate in varying transmission protocols such as A664P7 and TSN. Second, the embodiments allow continued use of legacy systems that operate on A664P7, which is advantageous for reducing cost by not having to replace otherwise reliable legacy components. Third, the embodiments assist in maintaining and/or improving the integrity, as an example, temporal integrity and/or high integrity ordinal integrity of the data packets being transmitted and received. Fourth, the embodiments support a mapping function between normal integrity data packets as well as high integrity data packets. Fifth, the embodiments support normal integrity A664P7, high integrity A664P7, normal integrity TSN, and/or high integrity TSN systems.

In another embodiment, a system for mapping data packets between two different data transmission formats, such as Time-sensitive Network (TSN) data format and ARINC 664 Part 7 (A664P7) data format, is disclosed. The system includes a processor and a memory in communication with the processor. The memory stores machine-readable instructions that, when executed by the processor, cause the processor to, in response to receiving a first data packet in a first data transmission format from a first data end system, form a second data packet in a second data transmission format based on the first data packet. The first data end system is capable of transmitting and receiving data packets in the first data transmission format. The first data transmission format is one of A664P7 data format and TSN data format and the second data transmission format is the other of A664P7 data format and TSN data format. The memory further stores machine-readable instructions that, when executed by the processor, cause the processor to transmit the second data packet to a second data end system. The second data end system is capable of receiving data packets in the second data transmission format.

In one embodiment, a method for mapping data packets between two different data transmission formats, such as Time-sensitive Network (TSN) data format and ARINC 664 Part 7 (A664P7) data format, is disclosed. The method includes, in response to receiving a first data packet in a first data transmission format from a first data end system, forming a second data packet in a second data transmission format based on the first data packet. The first data end system is capable of transmitting and receiving data packets in the first data transmission format. The first data transmission format is one of A664P7 data format and TSN data format and the second data transmission format is the other of A664P7 data format and TSN data format. The method further includes transmitting the second data packet to a second data end system capable of receiving data packets in the second data transmission format.

In another embodiment, a non-transitory computer-readable medium mapping data packets between two different data transmission formats, such as Time-sensitive Network (TSN) data format and ARINC 664 Part 7 (A664P7) data format, is disclosed. The non-transitory computer-readable medium includes instructions that when executed by a processor cause the processor to, in response to receiving a first data packet in a first data transmission format from a first data end system, form a second data packet in a second data transmission format based on the first data packet. The first data end system is capable of transmitting and receiving data packets in the first data transmission format. The first data transmission format is one of A664P7 data format and TSN data format and the second data transmission format is the other of A664P7 data format and TSN data format. The instructions further include instructions that when executed by a processor cause the processor to transmit the second data packet to a second data end system capable of receiving data packets in the second data transmission format.

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in the figures, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

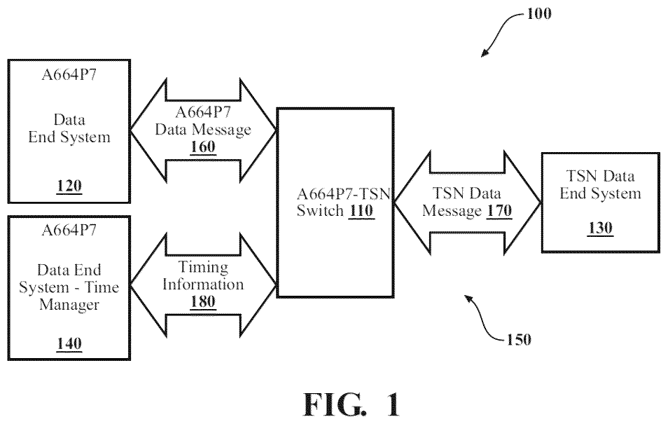

FIG. 1 illustrates an example of a network system 100 that includes an A664P7-TSN switch 110. As shown, the network system 100 may include one or more networking end nodes (also referred to as “end stations” and “end systems”) 120, 130 and an end system time manager 140. The networking end nodes 120, 130 may include at least one A664P7 data end system 120 and at least one TSN data end system 130. Further, the end system time manager may be an A664P7 data end system time manager 140. The end systems 120, 130 and the end system time manager 140 can be configured to be communicatively coupled by way of a series of data transmission pathways 150 and one or more A664P7-TSN switches 110. The data transmission pathways 122 can include a physical connection between the networking end nodes 120, 130 such as a wired connection including Ethernet, or can include wireless transmission connections, including, but not limited to, WiFi (e.g., 802.11 networks), Bluetooth, and the like.

The TSN data end system is capable of receiving and transmitting TSN data packets 170. The A664P7 data end system 120 is capable of receiving and transmitting A664P7 data packets 160. The A664P7 data end system time manager 140 including timing information 180 for components within the network 100. As an example, the A664P7 data end system time manager may include time stamp information, as well as time and clock offsets between various components within the network 100.

The A664P7-TSN switch 110 may receive and transmit data packets 160, 170 between the A664P7 data end system 120 and the TSN data end system 130 via the data transmission pathways 150. The A664P7 data end system 120 transmits and receives data packets 160 in an A664P7 data transmission format, while the TSN data end system 130 transmits and receives data packets 170 in a TSN data transmission format. As an example, the A664P7-TSN switch 110 receives a first data packet 160 from the A664P7 data end system 120. The first data packet 160 is in the A664P7 data transmission format. The A664P7-TSN switch 110 generates a second data packet 170 that is in the TSN data transmission format and is based on the contents of the first data packet 160. The A664P7-TSN switch 110 then transmits the second data packet 170 to the TSN data end system 130. As another example, the A664P7-TSN switch 110 receives a first data packet 170 from the TSN data end system 130. The first data packet 170 is in the TSN data transmission format. The A664P7-TSN switch 110 generates a second data packet 160 that is in the A664P7 data transmission format and is based on the contents of the first data packet 170. The A664P7-TSN switch 110 then transmits the second data packet 160 to the A664P7 data end system 120. Collectively, the end systems 120, 130, data transmission pathways 150, and A664P7-TSN switches 110 can form an avionics data network for an aircraft.

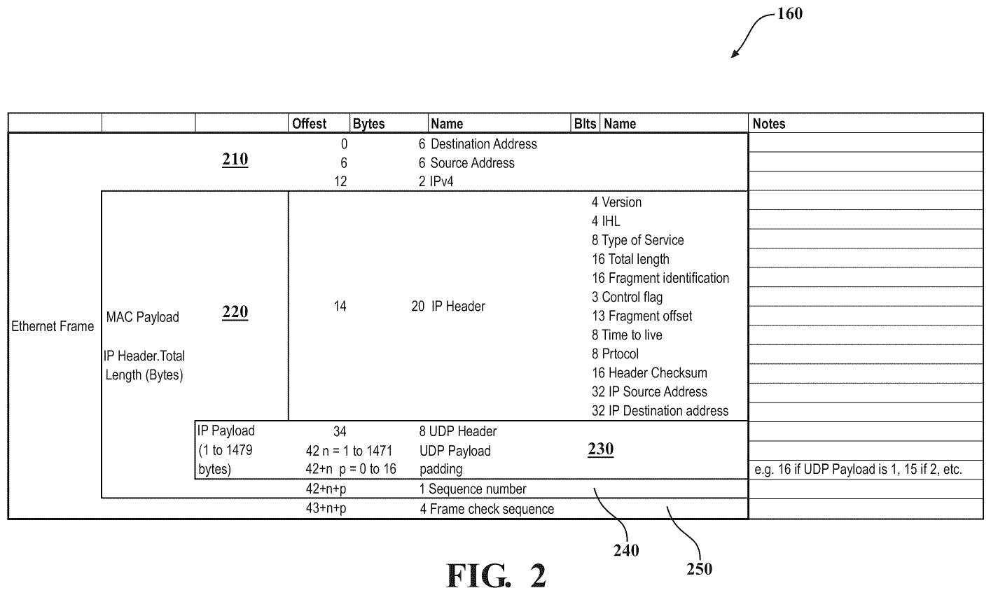

FIG. 2 illustrates an example of an A664P7 data packet 160 in A664P7 data format. The A664P7 data packet 160 is based on an Ethernet frame and as such, the A664P7 data packet 160 may include an Ethernet Header 210, a MAC payload 220, an IP payload 230, a Sequence Number 240, and a Frame Check Sequence 250.

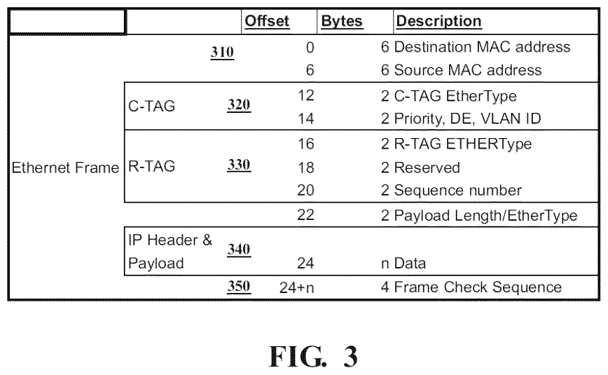

FIG. 3 illustrates an example of a TSN data packet 170 in TSN data format. The TSN data packet 170 is based on an Ethernet frame and as such, the TSN data packet 170 may include an Ethernet Header 310, a customer VLAN tag (C-TAG) 320, redundancy tag (R-TAG) 330, an IP header and IP payload 340, and Frame Check Sequence 350.

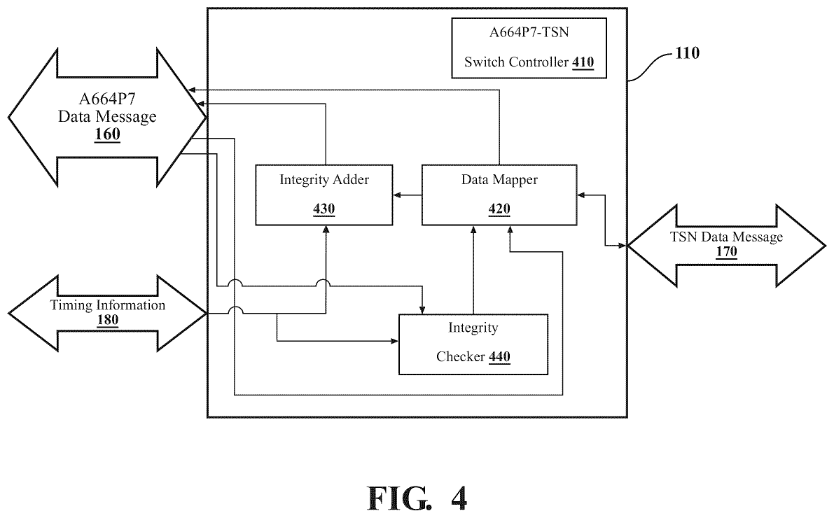

FIG. 4 illustrates one embodiment of the A664P7-TSN switch 110 that includes an A664P7-TSN switch controller 410. The A664P7-TSN switch 110 may further include a data mapper 420, an integrity adder 430, and/or an integrity checker 440.

The data mapper 420 is capable of mapping data from the A664P7 data format to the TSN data format and from the TSN data format to the A664P7 data format. As an example, the data mapper 420 receives the A664P7 data packet 160, generates a new data packet 170 in the TSN data format, and then populates the new data packet 170 based on the contents of the A664P7 data packet 160. More specifically, the C-TAG 320, the R-TAG 330, and the IP header and IP payload 340 of the new data packet 170 are populated based on the MAC payload 220 and the IP payload 230 of the A664P7 data packet 160. The data mapper 420 then outputs the new data packet 170 in the TSN data format as the TSN data packet 170 to the TSN data end system 130 via the data transmission pathways 150.

As another example, the data mapper 420 receives a TSN data packet 170, generates a new data packet 160 in the A664P7 data format, and then populates the new data packet 160 based on the contents of the TSN data packet 170. More specifically, the MAC payload 220 and the IP payload 230 of the new data packet 160 are populated based on the IP header and IP payload 340 of the TSN data packet 170. The sequence number 240 is populated based on the R-TAG 330 of the TSN data packet. The sequence number 240 will be based on the order in which the TSN data packets 170 were received. The data mapper 420 then outputs the new data packet 160 in the A664P7 data format as the A664P7 data packet 160 to the A664P7 data end system 120 via the data transmission pathways 150. Additionally and/or alternatively, the data mapper 420 may output the A664P7 data packet 160 to the integrity adder 430.

The integrity adder 430 is capable of populating one or more integrity fields in the A664P7 data packet 160. The one or more integrity fields will include a high integrity ordinal integrity field, a time integrity field, and a data integrity field. The time integrity field includes a timestamp also from the A664P7 data end system time manager 140.

The integrity adder 430 will receive timing information from the A664P7 data end system time manager 140. The integrity adder 430 may then include the sequence number and time stamp in integrity fields within the A664P7 data packet 160. More specifically, the integrity adder 430 may include the sequence number and time stamp within the UDP payload portion of the IP payload 230. The integrity adder 430 may then transmit the A664P7 data packet 160 to the A664P7 data end system 120 via the data transmission pathways 150.

The integrity checker 440 is capable of determining whether an A664P7 data packet 160 is valid based on the integrity field within the A664P7 data packet 160. The integrity checker 440 receives the A664P7 data packet 160 from the A664P7 end system 120. The integrity checker 440 also receives timing information from the A664P7 data end system time manager 140. The integrity checker 440 compares the sequence number in the high integrity ordinal integrity field to the expected sequence number and also compares the time stamp in the time integrity field with the expected time stamp. Upon determining that the sequence number in the high integrity ordinal integrity field matches the expected sequence number and the timestamp in the time integrity field matches the expected time stamp, the integrity checker 440 determines that the associated A664P7 data packet 160 is valid. The integrity checker 440 may then output the A664P7 data packet 160 to the data mapper 420 with an additional bit signal indicating that the A664P7 data packet 160 is valid. Alternatively, the integrity checker 440 may output the A664P7 data packet 160 to the data mapper 420 without any additional bit signals. In a case where the integrity checker 440 determines one or more of the sequence number or the time stamp in the A664P7 data packet 160 do not match the expected sequence number or time stamp, respectively, the integrity checker 440 may discard the A664P7 data packet 160 and not transmit the A664P7 data packet 160 to the data mapper 420. Alternatively, the integrity checker 440 may transmit the invalid A664P7 data packet 160 to the data mapper 420 with an additional bit signal indicating that the A664P7 data packet 160 is invalid.

The A664P7-TSN switch controller 410 includes control settings for the A664P7-TSN switch 110. The control settings may include, as an example, whether the A664P7 data packets 160 are high integrity A664P7 data packets that include the high integrity ordinal integrity field and/or the time integrity field.

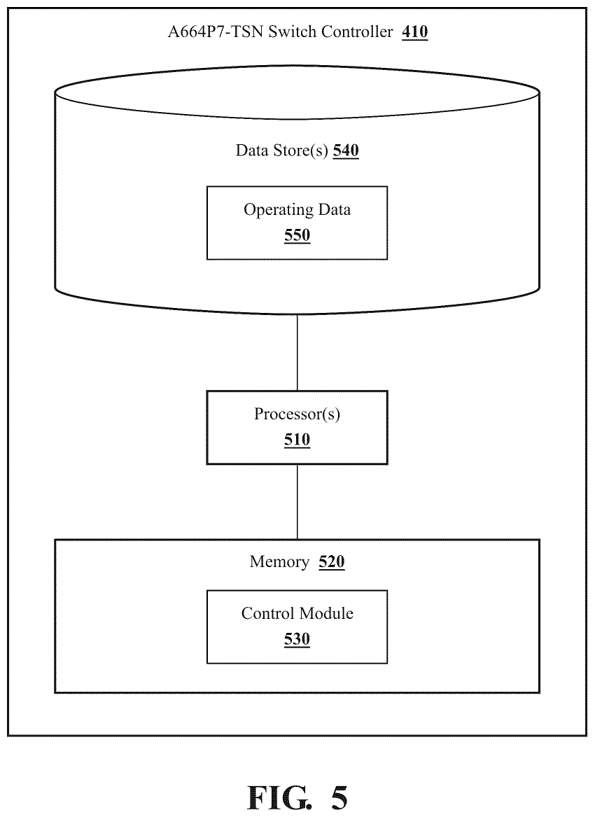

With reference to FIG. 5, a block diagram of an A664P7-TSN switch controller 410 is shown. The A664P7-TSN switch controller 410 is a control unit within the A664P7-TSN switch 110. The A664P7-TSN switch controller 410 may include a processor(s) 510. Accordingly, the processor(s) 510 may be a part of the A664P7-TSN switch controller 410, or the processor(s) 510 may be external to the A664P7-TSN switch controller 410 such that the A664P7-TSN switch controller 410 may access the processor(s) 510 through a data bus or another communication pathway 150. In one or more embodiments, the processor(s) 510 is an application-specific integrated circuit that may be configured to implement functions associated with a control module 530. More generally, in one or more aspects, the processor(s) 510 is an electronic processor, such as a microprocessor that can perform various functions as described herein when loading the control module 530 and executing encoded functions associated therewith.

The A664P7-TSN switch controller 410 may include a memory 520 that stores the control module 530. The memory 520 may be a random-access memory (RAM), read-only memory (ROM), a hard disk drive, a flash memory, or other suitable memory for storing the control module 530. The control module 530 is, for example, a set of computer-readable instructions that, when executed by the processor(s) 510, cause the processor(s) 510 to perform the various functions disclosed herein. While, in one or more embodiments, the control module 530 is a set of instructions embodied in the memory 520, in further aspects, the control module 530 may include hardware, such as processing components (e.g., controllers), circuits, etc., for independently performing one or more of the noted functions.

The A664P7-TSN switch controller 410 may include a data store(s) 540 for storing one or more types of data. Accordingly, the data store(s) 540 may be a part of the A664P7-TSN switch controller 410, or the A664P7-TSN switch controller 410 may access the data store(s) 540 through a data bus or another communication pathway. The data store(s) 540 is, in one embodiment, an electronically based data structure for storing information. In at least one approach, the data store 540 is a database that is stored in the memory 520 or another suitable medium, and that is configured with routines that can be executed by the processor(s) 510 for analyzing stored data, providing stored data, organizing stored data, and so on. In either case, in one embodiment, the data store 540 stores data used by the control module 530 in executing various functions. In one embodiment, the data store 540 may be able to store operating data 550 and/or other information that is used by the control module 530. The operating data 550 may include control settings such as settings indicating that the A664P7 data packets 160 and/or the TSN data packets 170 are normal integrity or high integrity data packets. Normal integrity packets do not include the high integrity ordinal integrity field, the time integrity field, or data integrity fields. High integrity packets may include the high integrity ordinal integrity field, the time integrity field, and data integrity fields.

The data store(s) 540 may include volatile and/or non-volatile memory. Examples of suitable data stores 540 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 540 may be a component of the processor(s) 510, or the data store(s) 540 may be operatively connected to the processor(s) 510 for use by the processor(s) 510. The term “operatively connected” or “in communication with” as used throughout this description, can include direct or indirect connections, including connections without direct physical contact.

In one embodiment, the control module 530 may include instructions that, when executed by the processor(s) 510, cause the processor(s) 510 to, in response to receiving a first data packet 160, 170 in a first data transmission format from a first data end system 120, 130, form a second data packet 170, 160 in a second data transmission format based on the first data packet 160, 170. The first data end system 120, 130 is capable of transmitting and receiving data packets 160, 170 in the first data transmission format. The first data transmission format is one of A664P7 data format and TSN data format and the second data transmission format is the other of A664P7 data format and TSN data format.

In one embodiment, the control module 530 may include instructions that, when executed by the processor(s) 510, cause the processor(s) 510 to form the second data packet 160, by appending at least one integrity field to the second data packet 160, wherein the second data transmission format is the A664P7 data format, and the second data end system is an A664P7 data end system 120. Content of the time integrity field is a timestamp generated or sourced from the A664P7 data end system time manager 140.

In one embodiment, the control module 530 may include instructions that, when executed by the processor(s) 510, cause the processor(s) 510 to determine validity of the first data packet 160 based on at least one integrity field within the first data packet 160. The control module 530 may cause the integrity checker 440 to check whether the contents of the high integrity fields match predetermined expected values. The A664P7 data end system time manager 140 may generate and provide the predetermined expected values. In a case where the contents of the high integrity fields match predetermined expected values, the integrity checker 440 may determine that the first data packet 160 is valid.

In some arrangements, the data packet 160 may include one or more of the integrity fields or one or more of the high integrity fields. As such, the data packet 160 may include one, two or more of the high integrity ordinal integrity field, the time integrity field, and the data integrity field. As an example, the data packet 160 may include the high integrity ordinal integrity field, the time integrity field, and the data integrity field.

In one embodiment, the control module 530 may include instructions that, when executed by the processor(s) 510, cause the processor(s) 510 to, in response to the first data packet 160 being valid, form the second data packet 170 in the second data transmission format based on the first data packet 160. The first data transmission format is A664P7 data format, the second data transmission is TSN data format, the first data end system is an A664P7 data end system 120, and the second data end system is a TSN data end system 130. In other words, in response to the integrity checker 440 indicating that the first data packet 160 is valid, the control module 530 may cause the integrity checker 440 to transmit the first data packet 160 to the data mapper 420, and then cause the data mapper 420 to generate the second data packet 170 based on the contents of the first data packet 160.

In one embodiment, the control module 530 may include instructions that, when executed by the processor(s) 510, cause the processor(s) 510 to transmit the second data packet 160, 170 to a second data end system 120, 130 capable of receiving data packets in the second data transmission format.

As an example, the first data packet is an A664P7 data packet 160, the first data transmission format is A664P7 data transmission format, and the first data end system is an A664P7 data end system 120. The second data packet is a TSN data packet 170, the second data transmission format is TSN data transmission format, and the second data end system is a TSN data end system 130. In such an example and in a case where the data packets 160, 170 are normal integrity, the control module 530 control settings indicate that the data A664P7 packets 160 are normal integrity. The control module 530 then causes the data mapper 420 to receive the A664P7 data packet 160 from the A664P7 data end system 120 via the data transmission pathways 150, generate a TSN data packet 170 based on the A664P7 data packet 160, and output the TSN data packet 170 to the TSN data end system 130 via the data transmission pathways 150. In such an example and in a case where the data packets 160, 170 are high integrity, the control module 530 control settings indicate that the data A664P7 packets 160 are high integrity. The control module 530 then causes the integrity checker 440 to receive the A664P7 data packet 160 and determine whether the A664P7 data packet 160 is valid based on the high integrity ordinal integrity field, the time integrity field, and the data integrity fields in the A664P7 data packet 160. In a case where the integrity checker 440 determines that the A664P7 data packet 160 is valid, the control module 530 may cause the integrity checker 440 to transmit the A664P7 data packet 160 to the data mapper 420. The control module 530 may then cause the data mapper 420 to receive the A664P7 data packet 160 from the integrity checker 440, generate a TSN data packet 170 based on the A664P7 data packet 160, and output the TSN data packet 170 to the TSN data end system 130 via the data transmission pathways 150. In a case where the integrity checker 440 determines that the A664P7 data packet 160 is invalid, the integrity checker 440 may indicate to the control module 530 that the A664P7 data packet 160 is invalid. In response and as an example, the control module 530 may cause the integrity checker 440 to discard the A664P7 data packet 160 and not transmit the A664P7 data packet 160 to the data mapper 420.

As another example, the first data packet is a TSN data packet 170, the first data transmission format is TSN data transmission format, and the first data end system is a TSN data end system 130. The second data packet is an A664P7 data packet 160, the second data transmission format is A664P7 data transmission format, and the second data end system is an A664P7 data end system 120. In such an example and in a case where the data packets 160, 170 are normal integrity, the control module 530 receives control settings indicating that the TSN data packets 170 are normal integrity. The control module 530 then causes the data mapper 420 to receive the TSN data packet 170 from the TSN data end system 130 via the data transmission pathways 150, generate an A664P7 data packet 160 based on the TSN data packet 170, and output the A664P7 data packet 160 to the A664P7 data end system 120 via the data transmission pathways 150. In such an example and in a case where the data packets 160, 170 are high integrity, the control module 530 control settings indicate that the TSN data packets 170 are high integrity. The control module 530 then causes the data mapper 420 to receive the TSN data packet 170 from the TSN data end system 130 via the data transmission pathways 150, generate an A664P7 data packet 160 based on the TSN data packet 170, and output the A664P7 data packet 160 to the integrity adder 430. The control module 530 causes the integrity adder 430 to receive the A664P7 data packet 160 and populate the high integrity ordinal integrity field, the time integrity field, and the data integrity fields in the A664P7 data packet 160 based on time information from the A664P7 data end system time manager 140. The control module 530 may then cause the integrity adder 430 to output the A664P7 data packet 160 to the A664P7 data end system 120 via the data transmission pathways 150.

In one embodiment, the first data packet 170 includes a first set of fields and the control module 530 may include instructions that, when executed by the processor(s) 510, cause the processor(s) 510 to form the second data packet 160 by populating a second set of fields based on the first set of fields. The second set of fields is part of the second data packet 160. The first set of fields may include a C-TAG 320, an R-TAG 330, and an IP header and IP payload 340, and the second set of fields may include a MAC payload 220, an IP payload 230, and a sequence number 240. In such an embodiment, the control module 530 may cause the data mapper 420 to receive the first data packet 170 that includes the first set of fields and extract data information from the first set of fields such as in the C-TAG 320, the R-TAG 330, and the IP header and IP payload 340. The control module 530 may cause the data mapper 420 to form the second data packet 160 such that the second data packet 160 includes the second set of fields and then populate the second set of fields such as the Mac payload 220, the IP payload 230, and the sequence number 240 based on the extracted data information.

In one embodiment, the first data packet 160 includes a first set of fields and the control module 530 may include instructions that, when executed by the processor(s) 510, cause the processor(s) 510 to form the second data packet 170 by populating a second set of fields based on the first set of fields. The second set of fields is part of the second data packet 170. The first set of fields may include a MAC payload 220, an IP payload 230, and a sequence number 240, and the second set of fields may include a C-TAG 320, a R-TAG 330, and an IP header and IP payload 340. In such an embodiment, the control module 530 may cause the data mapper 420 to receive the first data packet 160 that includes the first set of fields and extract data information from the first set of fields such as in the MAC payload 220 and the IP payload 230. The control module 530 may cause the data mapper 420 to form the second data packet 170 such that the second data packet 170 includes the second set of fields and then populate the second set of fields such as the C-TAG 320, the R-TAG 330, and the IP header and IP payload 340 based on the extracted data information.

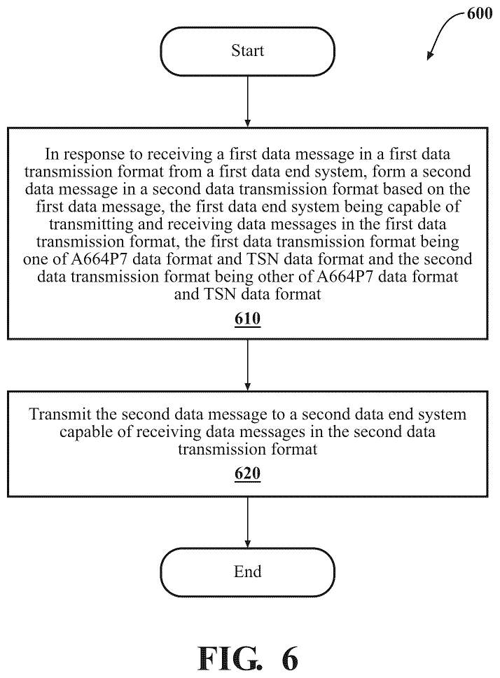

FIG. 6 is a flowchart illustrating one embodiment of a method 600 for mapping between A664P7 data packets 160 and TSN data packets 170. The method 600 will be described from the viewpoint of the A664P7-TSN switch 110 of FIG. 1 and the A664P7-TSN switch controller 410 of FIG. 4. However, the method 600 may be adapted to be executed in any one of several different situations and not necessarily by the A664P7-TSN switch 110 or the A664P7-TSN switch controller 410.

At step 610, the control module 530 may cause the processor(s) 510 to, in response to receiving a first data packet 160, 170 in a first data transmission format from a first data end system 120, 130, form a second data packet 170, 160 in a second data transmission format based on the first data packet 160, 170. The first data end system 120, 130 is capable of transmitting and receiving data packets 160, 170 in the first data transmission format. The first data transmission format is one of A664P7 data format and TSN data format and the second data transmission format is other of A664P7 data format and TSN data format. The first data packet 160, 170 includes a first set of fields and the second data packet 170, 160 includes a second set of fields. In one arrangement, the first set of fields includes a C-TAG 320, an R-TAG 330, and an IP header and IP payload 340, and the second set of fields includes a MAC payload 220, an IP payload 230, and a sequence number 240. In another arrangement, first set of fields includes a MAC payload 220, an IP payload 230, and a sequence number 240, and wherein the second set of fields includes a C-TAG 320, an R-TAG 330, and an IP header and IP payload 340. The control module 530 may cause the processor(s) 510 to form the second data packet 170, 160 by populating a second set of fields based on the first set of fields. The A664P7-TSN switch 110 may include both arrangements such that the control module 530 may cause the processor(s) 510 to form the second data packet 170, 160, where the first data packet is a TSN data packet 170 and the second data packet is an A664P7 data packet 160, and where the first data packet is an A664P7 data packet 160, and the second data packet is a TSN data packet 170.

At step 620, the control module 530 may cause the processor(s) 510 to transmit the second data packet 170, 160 to a second data end system 130, 120 capable of receiving data packets 160, 170 in the second data transmission format. In a case where the first data packet is the A664P7 data packet 160 that is also high integrity and the second data packet is the TSN data packet 170, the control module 530 may cause the processor(s) 510 to determine validity of the A664P7 data packet 160 based on the high integrity ordinal integrity field, the time integrity field, and the data integrity fields within the A664P7 data packet 160 and in response to the A664P7 data packet 160 being valid, form the TSN data packet 170 in the TSN data transmission format based on the A664P7 data packet 160, and transmit the TSN data packet 170 to the TSN data end system 130. In a case where the first data packet is the TSN data packet 170 and the second data packet is the A664P7 data packet 160 that is also high integrity, the control module 530 may cause the processor(s) 510 to form the A664P7 data packet 160 in the A664P7 data transmission format based on the TSN data packet 170, add the high integrity ordinal integrity field, the time integrity field, and the data integrity fields to the A664P7 data packet 160, and transmit the A664P7 data packet 160 to the A664P7 data end system 120.

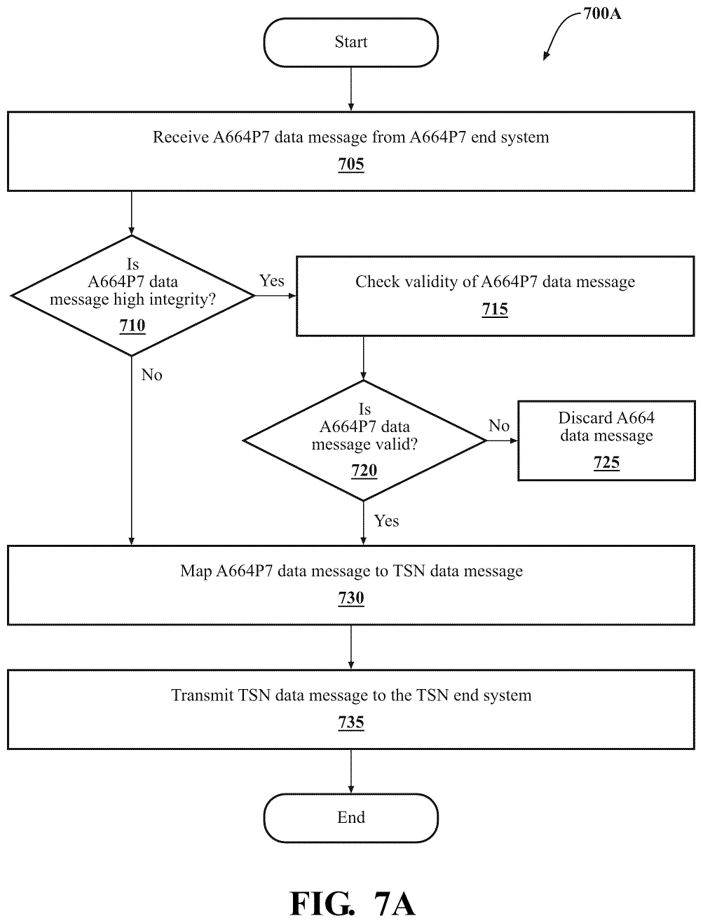

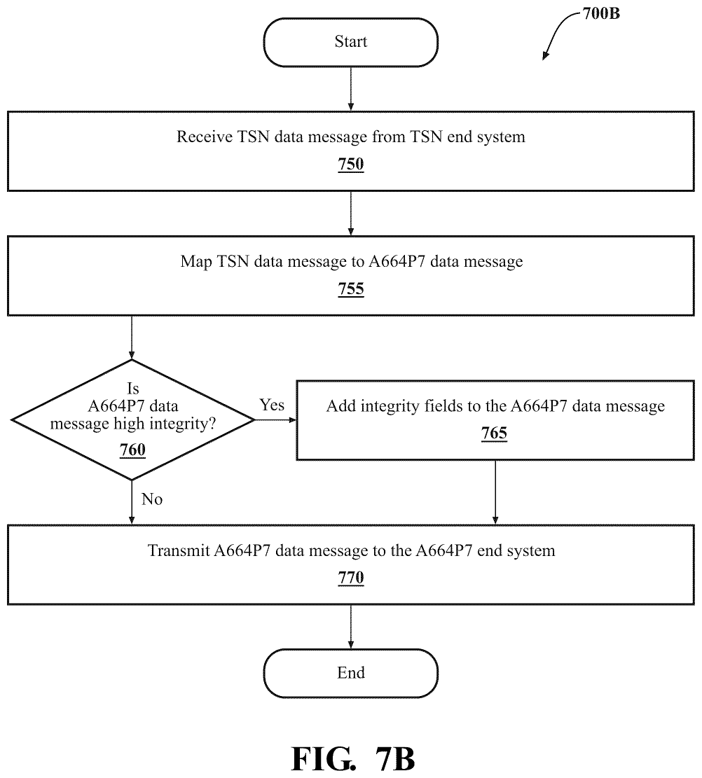

FIGS. 7A-7B are flowcharts illustrating methods 700A, 700B for mapping between A664P7 data packets 160 and TSN data packets 170. FIG. 7A is a flowchart illustrating one embodiment of a method 700A for mapping from A664P7 data packets 160 to TSN data packets 170. FIG. 7B is a flowchart illustrating one embodiment of a method 700B for mapping from TSN data packets 170 to A664P7 data packets 160. The methods 700A, 700B will be described from the viewpoint of the A664P7-TSN switch 110 of FIG. 1 and the A664P7-TSN switch controller 410 of FIG. 4. However, the methods 700A, 700B may be adapted to be executed in any one of several different situations and not necessarily by the A664P7-TSN switch 110 or the A664P7-TSN switch controller 410. As previously mentioned, a single A664P7-TSN switch and/or A664P7-TSN switch controller may perform both methods 700A, 700B.

Starting with method 700A, at step 705, the control module 530 may cause the processor(s) 510 to receive an A664P7 data packet 160 from an A664P7 data end system 120. The next step is step 710.

At step 710, the control module 530 may determine whether the A664P7 data packet 160 is normal integrity or high integrity based on control settings within the A664P7-TSN switch 110. If the control module 530 determines that the A664P7 data packet 160 is normal integrity, the next step is step 730. If the control module 530 determines that the A664P7 data packet 160 is high integrity, the next step is step 715.

At step 715, the control module 530 may cause the processor(s) 510 to check the validity of the A664P7 data packet 160 based on the high integrity fields of the A664P7 data packet 160. The control module 530 may send a signal to the integrity checker 440 to compare the contents of the high integrity field in the A664P7 data packet 160 to predetermined values such as timing information 180 generated and/or stored by the A664P7 data end system time manager 140. In response, the integrity checker 440 compares the contents of the integrity fields in the A664P7 data packet 160 to the predetermined values generated and/or stored by the A664P7 data end system time manager 140. The next step is step 720.

At step 720, if the integrity checker 440 determines that the contents of the integrity fields match the predetermined values, the integrity checker 440 then determines that the A664P7 data packet 160 is valid and transmits the A664P7 data packet 160 to the data mapper 420. In such a case, the next step is step 730. If the integrity checker 440 determines that the contents of the integrity fields do not match the predetermined values, the integrity checker 440 then determines that the A664P7 data packet 160 is not valid, and the next step is step 725. In such a case, the next step is step 730.

At step 725, the control module 530 may cause the processor(s) 510 to discard the A664P7 data packet 160 and the process ends.

At step 730, the control module 530 may cause the processor(s) 510 to map the contents of the A664P7 data packet 160 to a TSN data packet 170. More specifically, the control module 530 may cause the data mapper 420 to map the contents of the A664P7 data packet 160 to the TSN data packet 170. As an example, the data mapper 420 may populate the Destination MAC address 310 of the TSN data packet 170 with the Destination MAC address 210 of the A664P7 data packet 160 and the Source MAC address 310 of the TSN data packet 170 with the Source address 210 of the A664P7 data packet 160. The data mapper 420 may then set C-TAG 320 by setting the C-TAG EtherType to 0x8100 and the VLAN ID field to 0xXXX, where the XXX is a configured value between 1 and 4094. The data mapper 420 may set the R-TAG 330 by setting the R-TAG EtherType to 0xF1C1, Reserved field to 0, and the Sequence number based on a counter. The data mapper 420 may then set the Payload length/EtherType field to 0x800. The data mapper 420 may then populate the IP header and IP payload 340 of the TSN data packet 170 with the contents of the IP header and the IP payload 230 of the A664P7 data packet 160. The next step is step 735.

At step 735, the control module 530 may cause the processor(s) 510 to transmit the TSN data packet 170 to the TSN data end system 130. The process ends.

For method 700B, at step 750, the control module 530 may cause the processor(s) 510 to receive a TSN data packet 170 from a TSN data end system 130. The next step is step 755.

At step 755, the control module 530 may cause the processor(s) 510 to map the contents of the TSN data packet 170 to an A664P7 data packet 160. More specifically, the control module 530 may cause the data mapper 420 to map the contents of the TSN data packet 170 to the A664P7 data packet 160. As an example, the data mapper 420 may populate the Destination MAC address 210 of the A664P7 data packet 160 with the Destination MAC address 310 of the TSN data packet 170 and the Source MAC address 210 of the A664P7 data packet 160 with the Source MAC address 310 of the TSN data packet 170. The data mapper 420 may then set the IPv4 field 210 to 0x800. The data mapper 420 may then populate the IP header and IP payload 230 of the A664P7 data packet 160 with the contents of the IP header and IP payload 340 of TSN data packet 170. The data mapper 420 may set the Sequence number 240 based on a counter. The next step is step 760.

At step 760, the control module 530 may determine whether the A664P7 data packet 160 is normal integrity or high integrity based on control settings within the A664P7-TSN switch 110. If the control module 530 determines that the A664P7 data packet 160 is normal integrity, the next step is step 770. If the control module 530 determines that the A664P7 data packet 160 is high integrity, the next step is step 765.

At step 765, the control module 530 may cause the processor(s) 510 to add high integrity fields to the A664P7 data packet 160. The control module 530 may send a signal to the integrity adder 430 to populate the high integrity fields in the A664P7 data packet 160 based on predetermined values generated by the A664P7 data end system time manager 140. In response, the integrity adder 430 receives the predetermined values and enters the predetermined values into the UDP payload in the IP payload 230 of the A664P7 data packet 160 and adds the data integrity fields. The next step is step 770.

At step 770, the control module 530 may cause the processor(s) 510 to transmit the A664P7 data packet 160 to the A664P7 data end system 120. The process ends.

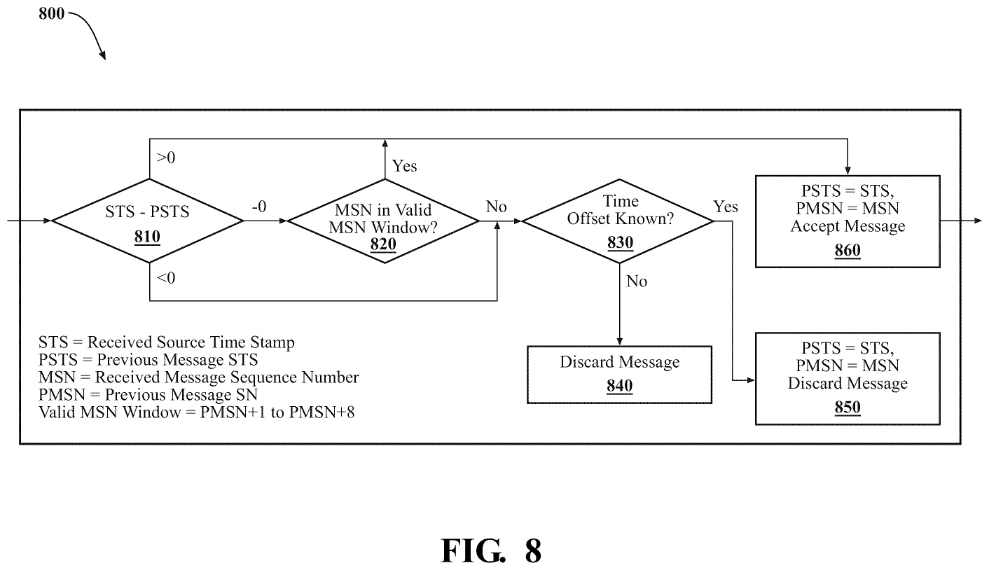

FIG. 8 is a flowchart illustrating one embodiment of a method 800 for high integrity ordinal integrity validation. The method 800 will be described from the viewpoint of the integrity checker 440 of FIG. 4. However, the method 800 may be adapted to be executed in any one of several different situations and not necessarily by the integrity checker 440.

At step 810, the integrity checker 440 compares the time stamp within a data packet 160 to a previous time stamp. If the time stamp of the data packet 160 is larger than the previous time stamp, the next step is step 860. If the time stamp of the data packet 160 is the same as the previous time stamp, the next step is step 820. If the time stamp of the data packet 160 is less than the previous time stamp, the next step is step 830.

At step 820, the integrity checker 440 determines whether the received message sequence number, which is the sequence number in the data packet 160, is within a predetermined range or window. If the sequence number is within the predetermined window, the next step is step 860. If the sequence number falls outside the predetermined window, the next step is step 830.

At step 830, the integrity checker 440 determines whether a time offset is known. If the time offset is not known, the next step is step 840. If the time offset is known, the next step is step 850.

At step 840, the integrity checker 440 discards the data packet 160. The process ends.

At step 850, the integrity checker 440 sets the previous time stamp to the time stamp within the data packet 160. The integrity checker 440 then discards the data packet 160. The process ends.

At step 860, the integrity checker 440 sets the previous time stamp to the time stamp within the data packet 160. The integrity checker 440 also determines that the data packet 160 is valid. The process ends.

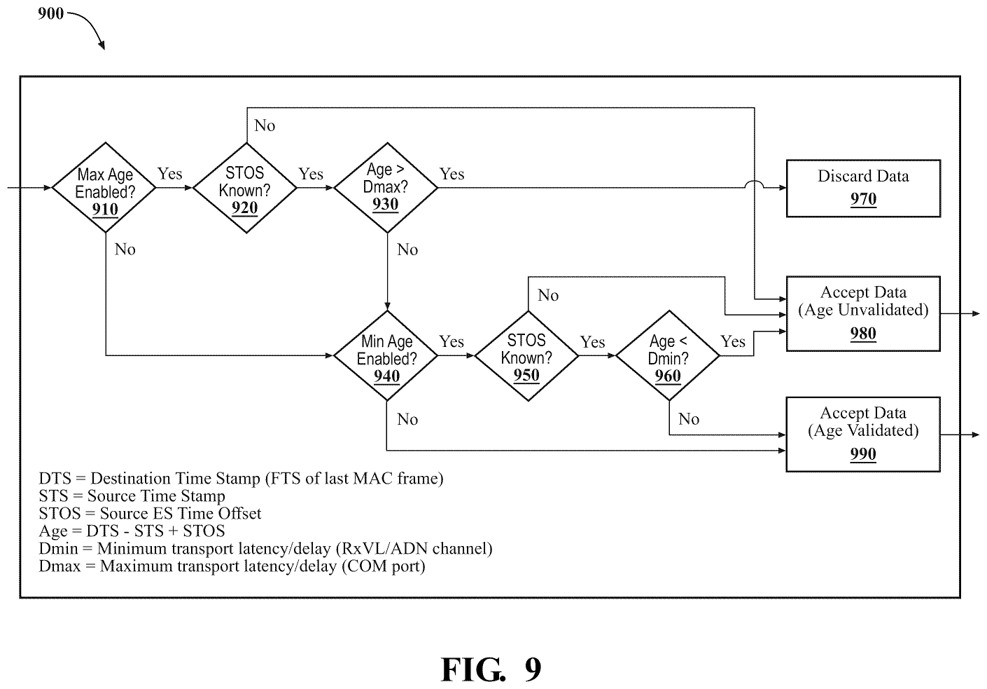

FIG. 9 is a flowchart illustrating one embodiment of a method 900 for high integrity time integrity validation. The method 900 will be described from the viewpoint of the integrity checker 440 of FIG. 4. However, the method 900 may be adapted to be executed in any one of several different situations and not necessarily by the integrity checker 440.

At step 910, the integrity checker 440 determines whether a maximum age limit for the data packet 160 has been enabled. The integrity checker 440 may check the configuration settings to determine whether the maximum age limit for the data packet 160 is enabled and/or set. If the maximum age limit is enabled, the next step is step 920. If the maximum age limit is not enabled, the next step is step 940.

At step 920, the integrity checker 440 determines whether the time offset between the source data end system 120 and the A664P7-TSN switch 110, or more specifically, the integrity checker 440 is known. As an example, the integrity checker 440 may receive the time offset from the A664P7 data end system time manager 140. If the time offset is known and received from the A664P7 data end system time manager 140, the next step is step 930. If the time offset is unknown and/or the time offset is not received from the A664P7 data end system time manager 140, the next step is step 980.

At step 930, the integrity checker 440 determines the age of the data packet 160 and whether the age of the data packet 160 exceeds the maximum transport delay between the data end system 120 and the A664P7-TSN switch 110. If the age of the data packet 160 exceeds the maximum transport delay, the next step is step 970. If the age of the data packet 160 does not exceed the maximum transport delay, the next step is step 940.

At step 940, the integrity checker 440 determines whether a minimum age limit for the data packet 160 has been enabled. The integrity checker 440 may check the configuration settings to determine whether the minimum age limit for the data packet 160 is enabled and/or set. If the minimum age limit is enabled, the next step is step 950. If the minimum age limit is not enabled, the next step is step 990.

At step 950, the integrity checker 440 determines whether the time offset between the source data end system 120 and the A664P7-TSN switch 110, or more specifically, the integrity checker 440 is known. As an example, the integrity checker 440 may receive the time offset from the A664P7 data end system time manager 140. If the time offset is known and received from the A664P7 data end system time manager 140, the next step is step 960. If the time offset is unknown and/or the time offset is not received from the A664P7 data end system time manager 140, the next step is step 980.

At step 960, the integrity checker 440 determines the age of the data packet 160 and whether the age of the data packet 160 is less than the minimum transport delay between the data end system 120 and the A664P7-TSN switch 110. If the age of the data packet 160 is less than the minimum transport delay, the next step is step 980. If the age of the data packet 160 is not less than the minimum transport delay, the next step is step 990.

At step 970, the integrity checker 440 discards the data packet 160. The process ends.

At step 980, the integrity checker 440 determines that the data packet 160 is valid even though the age of the data packet 160 has not been validated. The process ends.

At step 990, the integrity checker 440 determines that the data packet 160 is valid and the age of the data packet 160 has been validated. The process ends.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in the figures above; however the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above may be realized in hardware or a combination of hardware and software and may be realized in a centralized fashion in one processing system or in a distributed fashion where different elements are spread across several interconnected processing systems. Any kind of processing system or another apparatus adapted for carrying out the methods described herein is suited. A typical combination of hardware and software may be a processing system with computer-usable program code that, when being loaded and executed, controls the processing system such that it carries out the methods described herein. The systems, components and/or processes also may be embedded in a computer-readable storage, such as a computer program product or other data programs storage device, readable by a machine, tangibly embodying a program of instructions executable by the machine to perform methods and processes described herein. These elements also may be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that may contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein may be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing machine-readable instructions that, when executed by the processor, cause the processor to:
in response to receiving a first data packet in a first data transmission format from a first data end system, form a second data packet in a second data transmission format based on the first data packet, the first data end system being capable of transmitting and receiving data packets in the first data transmission format, the first data transmission format being one of ARINC 664 Part 7 (A664P7) data format and Time-Sensitive Network (TSN) data format, and the second data transmission format being other of A664P7 data format and TSN data format; and
transmit the second data packet to a second data end system capable of receiving data packets in the second data transmission format.

2. The system of claim 1, wherein the first data packet includes a first set of fields; and wherein the machine-readable instructions further include instructions that when executed by the processor cause the processor to:
form the second data packet by populating a second set of fields based on the first set of fields, wherein the second set of fields is part of the second data packet, wherein the first set of fields includes a customer VLAN tag (C-TAG), a redundancy tag (R-TAG), an IP header, and IP payload, and wherein the second set of fields includes a MAC payload and an IP payload.

3. The system of claim 1, wherein the first data packet includes a first set of fields; and wherein the machine-readable instructions further include instructions that when executed by the processor cause the processor to:
form the second data packet by populating a second set of fields based on the first set of fields, wherein the second set of fields is part of the second data packet, wherein the first set of fields includes a MAC payload and an IP payload, and wherein the second set of fields includes a customer VLAN tag (C-TAG), a redundancy tag (R-TAG), an IP header, and IP payload.

4. The system of claim 1, wherein the machine-readable instructions further include instructions that when executed by the processor cause the processor to:
form the second data packet by including at least one high integrity field in the second data packet, wherein the second data transmission format is the A664P7 data format, and the second data end system is an A664P7 data end system.

5. The system of claim 4, wherein the at least one high integrity field is one of:
a high integrity ordinal integrity field;
a time integrity field; or
a data integrity field.

6. The system of claim 4, wherein content of the at least one high integrity field is based on an A664P7 data end system time manager.

7. The system of claim 1, wherein the machine-readable instructions further include instructions that when executed by the processor cause the processor to:
determine validity of the first data packet based on at least one high integrity field within the first data packet; and
in response to the first data packet being valid, form the second data packet in the second data transmission format based on the first data packet, wherein the first data transmission format is A664P7 data format, the second data transmission is TSN data format, the first data end system is an A664P7 data end system, and the second data end system is a TSN data end system.

8. A method, comprising:
in response to receiving a first data packet in a first data transmission format from a first data end system, forming a second data packet in a second data transmission format based on the first data packet, the first data end system being capable of transmitting and receiving data packets in the first data transmission format, the first data transmission format being one of ARINC 664 Part 7 (A664P7) data format and Time-Sensitive Network (TSN) data format, and the second data transmission format being other of A664P7 data format and TSN data format; and
transmitting the second data packet to a second data end system capable of receiving data packets in the second data transmission format.

9. The method of claim 8, wherein the first data packet includes a first set of fields; and further comprising:
forming the second data packet by populating a second set of fields based on the first set of fields, wherein the second set of fields is part of the second data packet, wherein the first set of fields includes a customer VLAN tag (C-TAG), a redundancy tag (R-TAG), an IP header and an IP payload, and wherein the second set of fields includes a MAC payload and an IP payload.

10. The method of claim 8, wherein the first data packet includes a first set of fields; and further comprising:
forming the second data packet by populating a second set of fields based on the first set of fields, wherein the second set of fields is part of the second data packet, wherein the first set of fields includes a MAC payload and an IP payload, and wherein the second set of fields includes a customer VLAN tag (C-TAG), a redundancy tag (R-TAG), an IP header, and an IP payload.

11. The method of claim 8, further comprising:
forming the second data packet by including at least one high integrity field to the second data packet, wherein the second data transmission format is the A664P7 data format, and the second data end system is an A664P7 data end system.

12. The method of claim 11, wherein the at least one high integrity field is one of:
a high integrity ordinal integrity field;
a time integrity field; or
a data integrity field.

13. The method of claim 11, wherein content of the at least one high integrity field is based on an A664P7 data end system time manager.

14. The method of claim 8, further comprising:
determining validity of the first data packet based on at least one high integrity field within the first data packet; and
in response to the first data packet being valid, forming the second data packet in the second data transmission format based on the first data packet, wherein the first data transmission format is A664P7 data format, the second data transmission is TSN data format, the first data end system is an A664P7 data end system, and the second data end system is a TSN data end system.

15. A non-transitory computer-readable medium including instructions that, when executed by a processor, cause the processor to:
in response to receiving a first data packet in a first data transmission format from a first data end system, form a second data packet in a second data transmission format based on the first data packet, the first data end system being capable of transmitting and receiving data packets in the first data transmission format, the first data transmission format being one of ARINC 664 Part 7 (A664P7) data format and Time-Sensitive Network (TSN) data format, and the second data transmission format being other of A664P7 data format and TSN data format; and
transmit the second data packet to a second data end system capable of receiving data packets in the second data transmission format.

16. The non-transitory computer-readable medium of claim 15, wherein the first data packet includes a first set of fields, and wherein the instructions include instructions to:
form the second data packet by populating a second set of fields based on the first set of fields, wherein the second set of fields is part of the second data packet, wherein the first set of fields includes a customer VLAN tag (C-TAG), a redundancy tag (R-TAG), an IP header, and IP payload, and wherein the second set of fields includes a MAC payload and an IP payload.

17. The non-transitory computer-readable medium of claim 15, wherein the first data packet includes a first set of fields; and wherein the instructions further include instructions that when executed by the processor cause the processor to:
form the second data packet by populating a second set of fields based on the first set of fields, wherein the second set of fields is part of the second data packet, wherein the first set of fields includes a MAC payload and an IP payload, and wherein the second set of fields includes a customer VLAN tag (C-TAG), a redundancy tag (R-TAG), an IP header, and IP payload.

18. The non-transitory computer-readable medium of claim 15, wherein the instructions further include instructions that when executed by the processor cause the processor to:
form the second data packet by adding at least one high integrity field to the second data packet, wherein the second data transmission format is the A664P7 data format, and the second data end system is an A664P7 data end system.

19. The non-transitory computer-readable medium of claim 18, wherein the at least one high integrity field is one of:
a high integrity ordinal integrity field;
a time integrity field; or
a data integrity field.

20. The non-transitory computer-readable medium of claim 18, wherein content of the at least one high integrity field is based on an A664P7 data end system time manager.
